(19) United States
(12) Patent Application Publication
(10) Pub. No.: US 2004/0125925 A1
(43) Pub. Date: Jul. 1, 2004

(54) Method of instant voice messaging and device for the implementation of such a message

(76) Inventor: Rodolphe Marsot, Grenoble (FR)

Correspondence Address: PERMAN & GREEN, 425 POST ROAD, FAIRFIELD, CT, 06824, US

(21) Appl. No.: 10/675,870

(22) Filed: Sep. 30, 2003

(30) Foreign Application Priority Data
Oct. 1, 2002 (FR) FR 02 12152

(51) Int. Cl. H04M 1/64; H04M 11/00

(52) U.S. Cl. 379/88.22; 379/88.13

(57) ABSTRACT

A conversion server is implemented after a voice messaging server. The conversion server retrieves a voice message, compresses it and inserts it in an MMS type multimedia message. The multimedia message is formatted according to an HTML/XML/SMIL type language. The message thus formatted is then routed, through a multimedia server of a telephony operator, up to an intended recipient terminal where it will be interpreted/consulted. The multimedia server itself may also format the multimedia message according to a user profile, and add advertising type contents for example to the message.

### BACKGROUND OF THE INVENTION

1. Field of the Invention

An object of the invention is a method of instant voice messaging and a device for the implementation of such a method.

The field of the invention is that of telephony and voice messaging. More particularly, the field of the invention is that of voice answering machines used to take messages from calling users when the called users, who subscribe to a messaging service, are not available.

It is an aim of the invention to give more depth to the voice messages when, after being recorded, they are listened to by the user for whom the voice message is intended. It is another aim of the invention to avoid having to store voice messages on a server. It is another aim of the invention to enable a telephony operator to propose and/or control a voice messaging service.

2. Brief Description of Related Developments

In the prior art, there are known voice-messaging services such as those proposed by mobile telephony operators. When a subscriber with a mobile telephony operator is unavailable, a calling user seeking to make contact with the user who is unavailable is automatically connected to a voice mailbox. This voice mailbox then puts out a greeting message after which the calling user may record a message. The connection with this voice mailbox is necessarily made by means of a telephone set, whether fixed or mobile.

Furthermore, the voice message recorded by the calling user is recorded on the apparatus, generally known as the voice server, that hosts the voice mailbox. The voice message is recorded in the server until the subscriber for whom it is intended consults the message and, as the case may be, erases it.

In the prior art, it is furthermore impossible to leave a voice message for a mobile telephony network subscriber except by using a telephone set. Indeed voice mailboxes are accessible solely through a telephone number.

In the prior art, it is also very cumbersome for the mobile telephony operator to implement the voice messaging service which, however, is indispensable to cover every case where the subscribers do not wish to be contacted directly, or every case where the subscribers are not in a zone covered by the mobile telephony operator.

In the invention these problems are resolved by connecting a voice message conversion server to the voice-messaging server. As a result of this, once the voice-messaging server has recorded a voice message, it transfers it to the conversion server. The voice-messaging server also transfers information on the voice message such as, for example, the date of reception of the voice message and an identifier of the person who has left the voice message. From this information, the conversion server produces a multimedia message comprising a shaping of this information. This shaping may, for example, take the form of a file in the HTML, XML, or other format, comprising information on date and origin, and the voice message itself. Once the conversion server has produced this message, it is converted into an MMS (Multimedia Messaging Service) type of voice messaging service.

In general, to enable a connection, the MMS server sends a notification to the terminal. The terminal is configured either for the immediate and automatic downloading of the message or for its downloading in deferred mode upon confirmation by the owner of the terminal.

Thus a user who is a subscriber to this type of voice messaging service has then configured his terminal so that it can receive MMS type messages. His terminal then regularly connects to the MMS server, or accepts push requests from the MMS server. This enables the terminal to receive the multimedia message comprising the voice message in the form of a compressed file. The compressed file is recorded for subsequent use by the user of the terminal.

The voice messages are kept on the voice server only until the conversion server has retrieved them in order to transmit them to the MMS server. The multimedia messages are recorded on the MMS server only until they have been transferred to the terminal of the user for whom the voice message is intended. Thus, there is no need to make provision for high storage capacities for the voice and/or multimedia messages. Indeed, with the invention, these messages are stored in the user's terminal.

Furthermore, since the operator has control over the MMS server, it is possible for it to insert information in the multimedia messages or to filter these multimedia messages.

SUMMARY OF THE INVENTION

An object of the invention therefore is a method of instant voice messaging in which a calling user, calling a called user, is connected to a voice messaging server, the method also comprising the following steps:

a greeting message is played to the calling user,

a voice message, sent by the calling user, is recorded on the voice server,

wherein the method also comprising the following steps:

a multimedia message is produced, this message comprising a file corresponding to the recorded voice message and multimedia information corresponding to the calling user,

the multimedia message is transmitted to the terminal,

the voice message and the multimedia message are erased.

An object of the invention is also an instant voice messaging device comprising a voice messaging server capable of receiving a voice message from a calling user connected to the voice messaging server, wherein the voice messaging server is connected to a conversion server capable of producing a multimedia message comprising a file corresponding to the voice message and intended for a called user.

### BRIEF DESCRIPTION OF THE DRAWINGS

The invention will be understood more clearly from the following description and from the accompanying figures. These figures are given purely by way of an indication and in no way restrict the scope of the invention. Of these figures:

FIG. 1 illustrates means implemented by the method according to the invention; and

FIG. 2 illustrates steps of the method according to the invention.

### DETAILED DESCRIPTION OF THE PREFERRED EMBODIMENT(S)

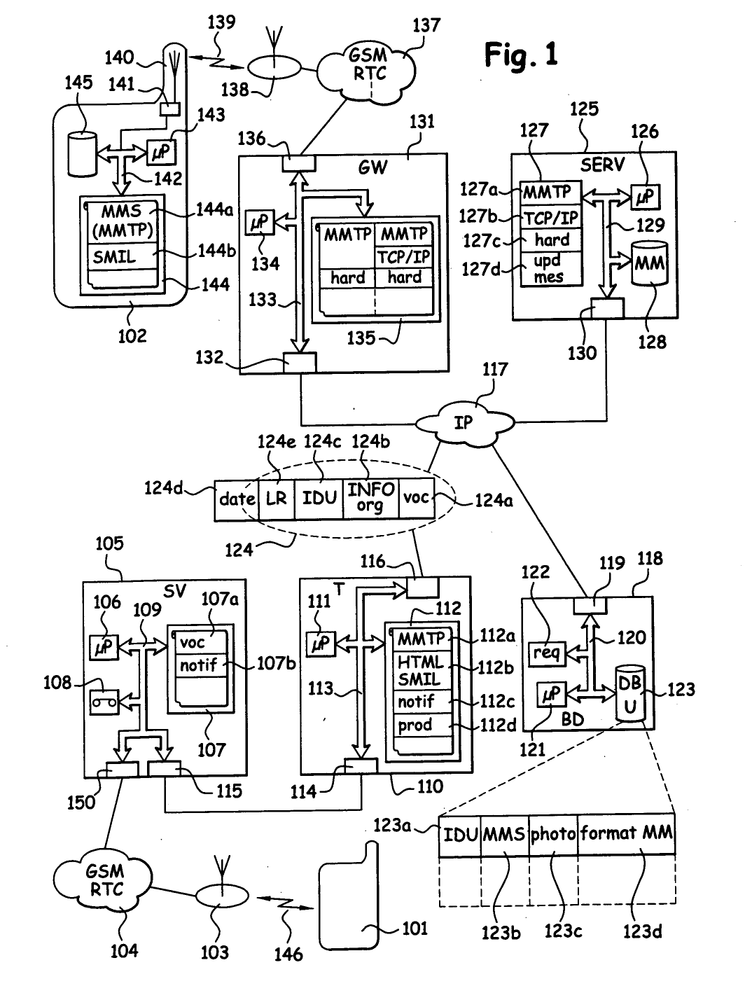

FIG. 1 shows a set or apparatus 101 used during a preliminary step 201 by a calling user seeking to make contact with a called user. In the step 201, the calling user has a called user identifier in order to try and make contact with him. For the purposes of the description, it is assumed that the apparatus 101 is a mobile telephone 101. In this case the identifier is a telephone number. In practice, the apparatus 101 could be a device of a completely different nature such as, for example, a personal computer, a laptop, a personal assistant, etc. The identifier too could be of any other nature such as, for example, any e-mail type electronic address, an instantaneous messaging type of electronic address (for example an ICQ address) etc.

In the step 201, the calling user dials the telephone number of the called user. The call is routed in a known way to the called user, and more particularly to an apparatus or telephone set of the called user which, in the present case, is a mobile telephone 102. In practice is possible that the calling user will seek to link up directly with a voice mailbox and therefore key in a number corresponding to this voice mailbox. Otherwise, there are various reasons why the calling user may find that he is connected to a voice mailbox. The most common reasons are either that the called user does not wish to be directly contacted, in which case he has turned off or deactivated his mobile telephone 102, or that the called user is not in the coverage zone of the operator with whom he has a subscription. In this case, the call of the calling user will be directly redirected toward a voice mailbox.

FIG. 1 shows that the apparatus 101, being a mobile telephone 101, is connected by an RF link 146 to a base station 103. The station 103 is itself connected to means for relaying the calls made by the user of the apparatus 101. These means 104 are, for example, the infrastructures of the GSM network and/or of a switched telephony network. Naturally, these could be other infrastructures such as, for example, an UMTS network, or any other implementation whatsoever of the telecommunications infrastructure. The apparatus 101 is therefore connected, through the means 103 and 104, to a voice server 105. The voice server 105 comprises means to record voice messages. The voice server 105 also comprises means to play a greeting message. The greeting message to be played depends on the identifier (telephone number) of the called user. It is indeed known that a user subscribing to a telephone network may personalize the greeting message of his voice mailbox. The means of the server 105 are therefore, broadly speaking, a microprocessor 106, a program memory 107, and a memory 108 for recording voice messages. Herein, we shall not describe the storage and selection mode for greeting messages. In practice, these greeting messages may be recorded in a database which is then addressed by the identifier of the called user. It is therefore easy in this way to retrieve the greeting message corresponding to the called user.

The elements 106 to 108 are connected by a bus 109. A microprocessor, for example the microprocessor 106, executes instruction codes recorded in a program memory such as the memory 107. The memory 107 has a zone 1 07A corresponding to instruction codes to implement the voice server function of the server 105. The server 105 also has circuits 150 to get connected to the means 104. These circuits 150 are an interface between the bus 109 and the means 104. The playing of the greeting message corresponds to a step 202 following the step 201. The step 202 ends usually with the sending of a sound signal informing the calling user that he can start speaking to produce the voice message that he wishes to leave for the called user. The operation passes from the step 202 to a step 203 for sending the voice message.

In the step 203 the calling user therefore speaks and the sounds that he sends are recorded in the memory 108 by the microprocessor 106. Conventionally and in association with the voice message, the server 105 also records the time of the call as well as an identifier of the caller. Once the calling user has finished his voice message, he hangs up. The recording format depends on the type of the memory 108. The memory 108 may be a tape, a floppy or a flash memory. A classic format is the WAV format.

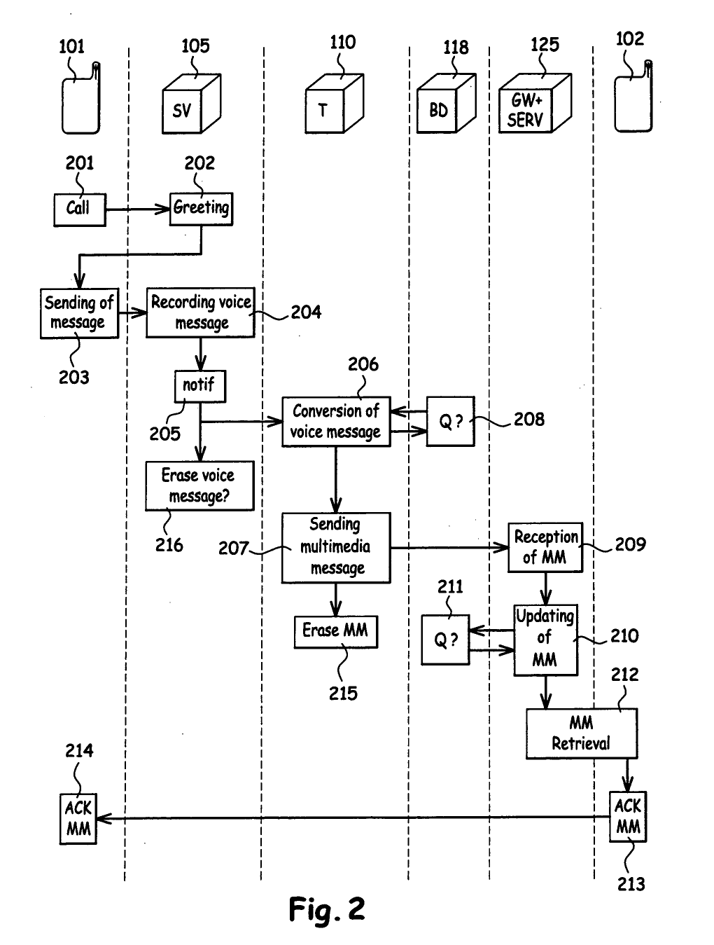

In FIG. 2 the step 203 is followed by a step 204 for recording the voice message. In practice, the steps 203 and 204 are simultaneous. Indeed, the voice message is recorded as and when it is sent by the calling user. The steps 203 and 204 therefore correspond to a same date seen firstly by the apparatus 101, and secondly the server 105.

The step 204 is followed by a notification step 205. To this end, the memory 107 comprises a zone 107B corresponding to the notification instruction codes. In the prior art, a notification consists in sending a message to the called user in order to inform him that a voice message has just been recorded in his voice mailbox. Such a message is generally notified through a short message.

In the invention, the notification message is sent to a conversion server 110. The notification message comprises at least one identifier of the called user. It also has a piece of information enabling this message to be identified as a message notifying reception of a voice call by the server 105.

The conversion server 110 comprises means to convert a voice message as recorded by the server 105 into a multimedia message. The server 110 comprises a microprocessor 111 connected to a program memory 112 via a bus 113. The server 110 also has connection interface circuits 114 for interfacing with circuits 115 of the server 105. The circuits 115 are connected to the bus 109. In the present example, the server 105 and the server 110 are shown as being two separate entities. In practice, the means of the server 110 could very well be incorporated into the server 105. This amounts to saying that the instruction codes of the server 110 would actually be recorded in the memory 107 and implemented by the microprocessor 106.

The memory 112 is divided into several zones. A zone 112A enables the implementation of the MMTP (Multimedia Message Transport Protocol). This is the transport protocol for multimedia messages as standardized in the MMS standard by the 3GPP group. The 3GPP is the working group standardizing third-generation mobile telephones.

The memory 112 comprises a zone 112B enabling the implementation of an HTML (HyperText Markup Language), XML (extensible Markup Language) or SMIL (pour Synchronized Multimedia Integration Language) type data-formatting language. These two languages define files that will subsequently be read by a program capable of understanding the instructions contained in these files. These instructions make it possible, inter alia, to display text and images as well as to read sound files.

A zone 112C comprises instruction codes enabling the server 110 to manage the notifications sent by the server 105. A zone 112D enables the production of a multimedia message of the MMS message type for example.

The server 110 also has interface circuits 116 for interfacing with a network 117 of the Internet type. The circuits 116 are therefore an interface between the Internet 117 and the bus 113. Through the network 117, the server 110 is capable of communicating with a profile server 118. The server 118 is managed by the mobile telephony operator with which the called user is a subscriber. The server 118 has an interface 119 for connection with the network 117. The interface 119 is connected to a bus 120, which is itself connected to a microprocessor 121, a program memory 122 and a storage unit 12. The memory 122 has instruction codes enabling the profile server 118 to respond to requests on the profiles of the users. The profiles of the users are recorded on the unit 123 in the form of a database. A part of this database may be represented in the form of a table comprising rows and columns. Each row then corresponds to a user and each column then corresponds to a characteristic of this user. A row is also called a profile.

A column 123A comprises an identifier of the user. This identifier is example his telephone number which has been assigned to him by the telephony operator with which he is a subscriber. A column 123B comprises a piece of information indicating whether or not the user has subscribed to the multimedia message option. A column 123C has a photograph of the user, and a column 123D has information on the formatting of the multimedia messages that the user wishes or does not wish to receive. In one variant, each row may also comprise the user's names and surnames, in the form of an electronic visiting card or VCARD, or a video of the user. All data formats are authorized.

In the step 205, the server 105 sends a message to the server 110. This is a notification message. The server 110 will then access the database 123. This access takes the form of a request for knowledge of the contents of the field 123B corresponding to the user called by the calling user. The server 118 will respond to this request. The response is a frame comprising all or part of the profile of the called user. This response frame preferably has a field corresponding to the column 123B. The server 110 then possesses the information according to which the called user has or has not taken a subscription to receive multimedia messages. If the called user has not taken the subscription, the called user will be notified of the arrival of the voice message as in the prior art, by a simple SMS. If not, the operation passes to a step 206 of conversion of the voice message into a multimedia message.

In the step 206, the server 110 asks the server 105 to send it the voice message in the form of a file. This transfer can be done, for example, according to the FTP or according to any other protocol used to exchange files. Once the server has transmitted the voice message to the server 110, this voice message is erased from the memory 108 by the server 105. This is the step 216 of erasure of the voice message. During the transmission of the voice message from the server 105 to the server 110, the server 105 also transmits the information accompanying the voice message, namely the date of recording of the voice message and the identifier of the person having recorded this message. This identifier is most usually the telephone number.

On the server 105, the voice message is recorded in any unspecified data format. The voice message is then transmitted to the server 110 either in this unspecified format or, possibly, compressed if this unspecified format is not sufficiently compressed. The compression may also take place on the server 110, or on the server 105. Whatever the case, the voice message that the server 110 has to incorporate into the multimedia message has a compressed format of the MP3, OGG, or MP4 type, to cite only the best-known types of format.

In the step 206, the conversion server 110 therefore possesses at least one compressed voice message, an identifier of the called user, an identifier of the calling user and the date of recording for the voice message. The conversion server can also be in possession of the subject of the message: when the voice message is deposited, the caller may have the option of indicating the subject of the message, its importance or its character depending on whether it is personnel, urgent, professional etc. From this information, the server 110 can therefore produce a multimedia message, for example of the MMS type, containing all this information. The MMS messages are governed by a standard defined by the 3GPP. MMS stands for MultiMedia Messaging Service. It is a service that can be used to convey messages comprising multimedia components, and text. The most frequent multimedia components are images, moving pictures, and sound.

In the step 206, the server 110 therefore constitutes a message 124 comprising a field 124A that comprises the compressed voice message, a field 124B comprising an identifier of the calling user, a field 124C comprising an identifier of the called user, and a field 124D comprising the date on which the voice message was recorded, and optionally, a field 124E indicating whether the calling user wishes to receive a message informing him that the called user has really received the voice message. Once constituted, this message 124 is sent to a multimedia message server 125.

The server 125 is managed by the operator with which the called user is a subscriber.

The server 125 has a microprocessor 126, a program memory 127 and a unit 128 for the storage of multimedia messages. The elements 126 to 128 are connected by a bus 129. The server 125 also has circuits 130, connected to the bus 129, acting as interfaces between the network 117 and the server 125. The memory 127 has a zone 127A used to implement the MMTP protocol. A zone 127B is used to implement the TCP/IP protocol, which is the transportation protocol used to send messages through the network 117. In general the TCP/IP protocol is also implemented by the servers 110 and 118.

For the sake of clarity, a zone 127C is shown corresponding to the management of the hardware layer of the network interface. This provides for a clearer understanding of the interactions between the multimedia message server 125 and a multimedia message gateway 131.

The memory 127 also has a zone 127D corresponding to the updating of the multimedia message 124 produced by the conversion server 110.

From the step 206, the operation passes to a step 207 in which the server 110 sends the multimedia message 124 to the multimedia server 125.

Through a step 208 of interrogation of the server 118 by the server 110, the message 124 may be formatted with greater precision. Indeed, it is possible for the conversion server 110 to get connected to the server 118 to obtain the profile of the called user, and more particularly the contents of the field 123D. This possibility shall not be dwelt upon here, because it will be described for the updating of the multimedia message by the server 125. It must be known however that all or part of this updating may be done at the server 110.

After the step 207, the server 110 no longer needs the multimedia message. It can therefore erase it in a step 215. From the step 207, the operation also passes to a step 209 in which the multimedia message 124 is received by the multimedia server 125.

The step 209 is a step characteristic of the reception of a message via the Internet 117 through protocol layers such as the TCP/IP and MMTP layers. Once the message is retrieved, the operation passes to a step 210 for updating this message. At the step 210, the server 125 is in possession of all the information described for the message 124.

This information will enable the server 125 to produce a message as illustrated here below:

<message>
<origin>
<msisdn>06 12 34 56 78</msisdn>
<readReport>1</readReport>
</origin>
<presentation>
<voc type=“voiceCoding”>0101110...0101</voc>
<img type=“imageCoding”
style=“imageStyle”>01111. .0101</img>
<text type=“textCoding” style=“textStyle”>text to be
displayed</text>
...
</presentation>
</message>

This example illustrates a shaping of the message via an XML type syntax. An appropriate syntax for the transmission of a message according to the invention is an HTML or SMIL type syntax. Herein, we have not cited the names of the tags of each of these two languages in order to remain as generic as possible. Here, each field is defined by an opening tag, <tag>, and a closing tag, </tag>. There are other ways of proceeding. For example, it may be decided that each field will begin with four bytes encoding the length of the field. The operation thus passes easily from one field to the next one.

The illustration thus shows a message comprising an original field that is itself divided into an MSISDN field and a “reading report” or “read report” field. The MSISDN defines the telephone number of the calling user and the reading report field states whether the calling user wishes to receive a message informing him that his voice message has truly been received by the called user. The MSISDN field may be replaced by any identifier whatsoever, for example an e-mail type electronic address, of the calling user.

The message also has a presentation field that is itself divided into several sub-fields. These sub-fields are, for example, the field ‘voc’ used to record a voice message, the field ‘img’ used to record an image, and the field ‘text’ used to record a text. Each of these three fields has an associated type indicating the format used to encode the contents of the field. Typically, the voice may be encoded according to the MP3 format, an image may be encoding according to the JPEG format, and a text may be encoded according to any set of characters whatsoever, for example the ISO 8859 1 alphabet. The sub-fields may also be accompanied by a field of styles defining the way in which they will be displayed. The style encompasses parameters used to define the position on a screen and/or a date on which they must be displayed, a color for the text or any other formatting that can be envisaged. For example, it is possible to envisage a style compatible with the cascaded style sheets also known as CSS and standardized by the W3C.

During the step 210, the server 125 can get connected to the server 118 to obtain the user's profile corresponding to the called user's identifier in a step 211. It may be imagined that this user can update his profile by sending a preformatted MMS message from his terminal, with his name, surname, video greeting message, voice greeting message, and/or VCARD to the instant messaging service. Indeed, the field 123D may define the way in which the user wishes these voice messages to be formatted. The field 123D can also define a filter that identifies users from whom the called user does not wish to receive voice messages. Such a filter is also called a blacklist.

An example of personalized formatting would be one in which the called user wishes to receive transmission not only of the voice message but also of a photograph of the calling user, his name, his surname and/or a VCARD. If the calling user is also a subscriber with the mobile telephony operator managing the server 125, then he will consult the base 123 through the network 117 in search of the identifier of the calling user to obtain the contents of the field 123C and include it in the multimedia message that he produces for the called user.

At the step 210, the server 125 may also add, to the multimedia message produced, information that it has not received through the message 124. Such information consists, for example, of advertising messages. It may also be information recapitulating the number of voice messages that it has received during an elapsed period of time.

These added messages may be inserted either as images, or as text, or as a voice message.

After the step 210 the operation passes to a step 212 for the retrieval of the multimedia messages by the terminal 102.

The server 125 is connected to the gateway 131 via the network 117. The gateway 131 has interface circuits 132 between the network 117 and a bus 133 of the gateway 131. The gateway 131 also has a microprocessor 134 and a program memory 135.

The gateway 131 also has interface circuits 136 between the bus 133 and a network 137 identical to the network 104. The network 137 is furthermore connected to a base station 138 that can be used to set up an RF connection 139 with the terminal 102. The elements of the gateway 131 are interconnected via the bus 133.

The terminal 102 therefore has an antenna 140, interface circuits 141 between the antenna and a bus 142 to which there are connected a microprocessor 143, a program memory 144 and a storage memory 145.

For FIG. 1, different memories have been described for the apparatuses. In practice, for a given memory, all these memories may be unified in one and the same component.

The memory 145 enables the terminal 102 to record the multimedia messages. The memory 144 is divided into several zones, including a zone 144A used to implement protocols related to the MMS standard, and a zone 144B enabling the interpretation of the multimedia messages formatted according to the SMIL language.

The memory 135 is divided, schematically speaking, into two zones. One zone enables the gateway to communicate with the network 117, and one zone enables the gateway 131 to communicate with the network 137. The memory zone 135 enabling communication with the network 117 comprises TCP/IP and MMTP hardware layers. The memory zone 135 enabling the gateway 131 to communicate with the network 137 comprises hardware and MMTP layers. The role of the gateway 131 is therefore that of performing the transcoding of the messages exchanged between the server 125 and the terminal 102.

For the step 212, the MMS standard lays down two methods by which the terminal 102 can retrieve the multimedia messages that are intended for it. Either the called user of the terminal 102 has parametrized his terminal so that it interrogates the server 125, or the called user using the terminal 102 has parametrized the terminal so that it accepts the incoming messages coming from the server 125. An incoming message is, for example, an SMS message forming a notification of the depositing of a voice message. The user then knows that he must retrieve a voice message. Through operation in PUSH mode, enabling the conversion server to record an MMS message in the terminal, a push message may also be an MMS message.

In both examples, the apparatus or telephone set 102 records the multimedia messages received, as formatted by the server 125, on the storage unit 145.. During this recording, the apparatus 102 informs its user that a new voice message has been recorded in the memory 145 and that it can be consulted.

The operation then passes to a step 213 for consulting and acknowledging the multimedia voice message. In the step 212, once the server 125 has transmitted the multimedia message to the terminal 102, the multimedia message is erased from the memory 128. The multimedia message then remains nowhere other than in the memory 145 of the. apparatus or telephone set 102.

In the step 213, the user of the apparatus 102, namely the called user, scans the memory 145 to read the new voice messages that he has just received. When he selects one of these messages, it is interpreted through instruction codes of the zone 144D. This prompts firstly the playing of the voice message by the apparatus 102, and secondly the display of the different multimedia elements of the multimedia message on the screen of the apparatus 102. The value of the SMIL language is that it enables synchronization between the various events constituted by the display of the multimedia elements of the message and the act of listening to them.

During the display of the multimedia message, the called user of the apparatus 102 is informed that the calling user wishes to receive an acknowledgement of reception of his message. The called user can then choose to send or not to send this acknowledgement. This acknowledgement may take the form of a short message (SMS) automatically sent by the apparatus 102, or a standard MMS message.

This short message will be received in a step 214 by the apparatus 101. This acknowledgement message comprises, for example, an identifier of the called user and a date on which this acknowledgement message was sent.

An implementation of this kind has several useful aspects. Firstly, the entity proposing the voice messaging service no longer has to be concerned with the storage of these voice messages since this storage is ultimately made at the terminal of the user who is the intended recipient of these voice messages. Secondly, a mobile telephony operator is in a position to propose an entry point for voice messaging to service providers. Indeed, it is enough that the service providers should be compatible with the server 125 for the operator to be able to offer voice messaging services to users subscribing with the operator managing the server 125. In doing so, the mobile telephony operator retains control of these voice messages because it goes through one of its servers. The operator thus maintains control over both the stream of multimedia messages and the contents of the multimedia messages. The implementation of the voice server and of the conversion server remains the responsibility of the service provider.

In one variant of the invention, the conversion step 206 may comprises a sub-step for transcoding the voice message into a text format. This amounts to carrying out voice recognition on the recorded voice message. This enables a very high compression rate. This voice recognition may be done from the voice server 105. In this variant, it is possible to envisage a back restitution of the recognized voice message. This amounts to producing sounds from a text file. This restitution will then be done by the terminal 102 . The recognized voice message can also be presented as a text.

In one variant of the invention, all or part of the communications made via the network 117 are encrypted in order to increase confidentiality.

The method according to the invention is considered to be an instant voice messaging method because the multimedia message is delivered to the called user without his having to take action, and because delivery is made as soon as possible. Inasmuch as it is impossible to deliver a message more quickly, this is considered to be instant messaging.

The invention can also be applied unambiguously to the reception of video messages which then replace the voice messages of the description. Only the server 105 is slightly different in this case because it must then enable the recording of voice and video messages.

What is claimed is:

1. A method of instant voice messaging in which a calling user, calling a called user, is connected to a voice messaging server, the method also comprising the following steps:
a greeting message is played to the calling user,
a voice message, sent by the calling user, is recorded on the voice server,
wherein the method also comprising the following steps:
a multimedia message is produced, this message comprising a file corresponding to the recorded voice message and multimedia information corresponding to the calling user,
the multimedia message is transmitted to the terminal of the called user,
the voice message and the multimedia message are erased.

2. A method according to claim 1, wherein the voice message of the voice server is erased once the multimedia message has been produced.

3. A method according to claim 1, wherein the multimedia message is erased once it has been transmitted to the called user.

4. A method according to claim 1, wherein a called user parametrizes a multimedia customer terminal to interrogate a multimedia server in order to retrieve the multimedia messages intended for the called user.

5. A method according to claim 1, wherein a called user parametrizes a multimedia customer terminal so that this customer terminal accepts push messages corresponding to the produced multimedia message.

6. A method according to claim 1 wherein, for the production of the multimedia message, a connection is made with a database to obtain production preferences associated with the called user for the formatting of the multimedia message.

7. A method according to claim 1 wherein, for the production of the multimedia message, a connection is made with a database to obtain information associated with the called user, in order to include this information in the multimedia message.

8. A method according to claim 1, wherein the multimedia message is produced by using an HTML type formatting language.

9. A method according to claim 1, wherein the produced multimedia message comprises an identifier of the called user.

10. A method according to claim 1, wherein the multimedia message comprises a piece of information to request the transmission of a message providing information on the reading, by the intended recipient, of the multimedia message.

11. An instant voice messaging device comprising a voice messaging server capable of receiving a voice message from a calling user connected to the voice messaging server, wherein the voice messaging server is connected to a conversion server capable of producing a multimedia message comprising a file corresponding to the voice message and intended for a called user, and wherein the conversion server and the multimedia server are connected to a database server comprising information on the users of the device.

12. A device according to claim 11, wherein the conversion server is connected to a multimedia server capable of transferring the multimedia message to a multimedia customer terminal.

13. A device according to claim 12, wherein the multimedia server is connected to the multimedia customer terminal through a multimedia gateway.

14. A device according to claim 11, wherein the multimedia server comprises a mass storage unit to save the multimedia messages that are not downloaded by the user to whom the message is addressed.
